(19) United States
(12) Patent Application Publication
(10) Pub. No.: US 2026/0223228 A1
(43) Pub. Date: Jul. 30, 2026

(54) TARGET SENSING METHOD, SYSTEM AND APPARATUS, AND COMMUNICATION DEVICE AND STORAGE MEDIUM

(71) Applicant: Beijing Xiaomi Mobile Software Co., Ltd., Beijing (CN)

(72) Inventors: Xinli WANG, Beijing (CN); Yang SHEN, Beijing (CN)

(73) Assignee: Beijing Xiaomi Mobile Software Co., Ltd., Beijing (CN)

(21) Appl. No.: 19/148,908

(22) PCT Filed: Jan. 17, 2023
(86) PCT No.: PCT/CN2023/072747

§ 371 Date: Jul. 17, 2025

(51) Int. Cl. H04W 76/16; H04W 48/16; H04W 76/14

(52) U.S. Cl. CPC H04W 76/16; H04W 48/16; H04W 76/14

(57) ABSTRACT

A target sensing method and system are disclosed, wherein a first user equipment (UE) performs a direct sensing operation on a target in coordination with a second UE. The method includes determining the second UE through proximity service direct discovery and establishing a direct communication link (e.g., PC5 interface) for collaborative sensing. A sensing parameter is determined based on an exchange of messages between the UEs, where the sensing request from the first UE includes a first parameter, and the second UE may respond with a second parameter. The sensing parameter may specify roles, target identity, sensing periodicity, and result computation responsibilities. Depending on capability information, either UE may compute the sensing result after completing the operation. Complementary methods are also provided for the second UE to initiate or respond to sensing coordination with the first UE.

### CROSS REFERENCE TO RELATED APPLICATION

This application is a National Stage of International Application No. PCT/CN2023/072747, filed on Jan. 17, 2023, which is incorporated by reference herein in its entirety for all purposes.

### TECHNICAL FIELD

The present disclosure relates to the field of wireless communication technology, but is not limited thereto and, in particular, to target sensing methods, systems and apparatuses, as well as a communication device and a storage medium.

### BACKGROUND

In the related art, communication-sensing integration in 5G systems means that sensing capabilities are provided by the same wireless communication system and infrastructure used for communication, which may involve scenarios of communication-assisted sensing, such as providing sensing services or sensing-assisted communication. For example, sensing information related to the communication channel or environment is used to improve the communication services of the 5G system itself. Exemplarily, sensing information may be used to assist in radio resource management, interference mitigation, beam management or mobility, or the like. At present, the direct sensing method based on user equipment (UE) is not perfect.

### SUMMARY

The embodiments of the present disclosure provide target sensing methods, system and apparatuses, as well as a communication device and a storage medium.

A first aspect of the embodiments of the present disclosure provides a target sensing method, which is performed by a first UE and includes:
performing a direct sensing operation on a sensed target with a second UE.

A second aspect of the embodiments of the present disclosure provides a target sensing method, which is performed by a second UE and includes:
performing a direct sensing operation on a sensed target with a first UE.

A third aspect of the embodiments of the present disclosure provides a target sensing system, including a first UE and a second UE; where
the first UE is configured to perform a direct sensing operation on a sensed target with the second UE; and
the second UE is configured to perform the direct sensing operation on the sensed target with the first UE.

A fourth aspect of the embodiments of the present disclosure provides a target sensing apparatus, which is applied to a first UE and includes:
a performing unit, configured to perform a direct sensing operation on a sensed target with a second UE.

A fifth aspect of the embodiments of the present disclosure provides a target sensing apparatus, which is applied to a second UE and includes:
an operating unit, configured to perform a direct sensing operation on a sensed target with a first UE.

A sixth aspect of the embodiments of the present disclosure provides a communication device, including a processor, a transceiver, a memory, and an executable program stored in the memory and capable of being run by the processor, where the processor, upon running the executable program, is configured to implement the target sensing method as described in any of the preceding embodiments.

A seventh aspect of the embodiments of the present disclosure provides a computer storage medium storing an executable program thereon, where the executable program, upon being executed by a processor, is used for implementing the target sensing method as described in any of the preceding embodiments.

The target sensing method according to some embodiments of the present disclosure is performed by the first UE and includes: performing the direct sensing operation on the sensed target with the second UE. In this way, direct sensing operation is performed on the sensed target by two UEs, without requiring UE to perform the sensing operation through any network-side device such as a base station, thereby being conducive to reducing interaction between the UE and the base station. Moreover, terminal capabilities of the two UEs are relied on. Compared with the sensing method relying on only one UE, the selectivity and fault tolerance of the terminal capabilities may be improved, thereby improving the sensing efficiency and success rate.

It should be understood that the foregoing general description and the following detailed description are exemplary and explanatory only and are not restrictive of the embodiments of the present disclosure.

### BRIEF DESCRIPTION OF THE DRAWINGS

The accompanying drawings, which are incorporated in and constitute a part of this specification, illustrate embodiments consistent with the present invention and, together with the description, serve to explain the principles of the embodiments of the present invention.

FIG. 1 is a schematic structural diagram of a wireless communication system according to an exemplary embodiment.

FIG. 2 is a schematic flow chart of a target sensing method according to an exemplary embodiment.

FIG. 3 is a schematic diagram of a sensing method in the related art.

FIG. 4 is a schematic diagram of a sensing method in the related art.

FIG. 5 is a schematic diagram of a sensing method in the related art.

FIG. 6 is a schematic diagram of a sensing method in the related art.

FIG. 7 is a schematic diagram of a sensing method in the related art.

FIG. 8 is a schematic diagram showing a sensing method according to an exemplary embodiment.

FIG. 9 is a flow chart of a target sensing method according to an exemplary embodiment.

FIG. 10 is a flow chart of a target sensing method according to an exemplary embodiment.

FIG. 11 is a flow chart of a target sensing method according to an exemplary embodiment.

FIG. 12 is a flow chart of a target sensing method according to an exemplary embodiment.

FIG. 13 is a flow chart of a target sensing method according to an exemplary embodiment.

FIG. 14 is a block diagram of a target sensing apparatus according to an exemplary embodiment.

FIG. 15 is a block diagram of a target sensing apparatus according to an exemplary embodiment.

FIG. 16 is a block diagram of a terminal according to an exemplary embodiment.

FIG. 17 is a block diagram of a communication device according to an exemplary embodiment.

### DETAILED DESCRIPTION

Here, exemplary embodiments will be described in detail, examples of which are shown in the accompanying drawings. When the following description refers to the drawings, unless otherwise indicated, the same numbers in different drawings represent the same or similar elements. The implementations described in the following exemplary embodiments do not represent all implementations consistent with the embodiments of the present invention. Instead, they are only examples of apparatuses and methods consistent with some aspects of the embodiments of the present invention.

The terms used in the embodiments of the present disclosure are only for the purpose of describing specific embodiments, and are not intended to limit the embodiments of the present disclosure. The singular forms of “a”, “said”, and “the” used in the present disclosure are also intended to include plural forms, unless the context clearly indicates other meanings. It should also be understood that the term “and/or” used in this article refers to and includes any or all possible combinations of one or more associated items as listed.

It should be understood that although the terms first, second, third, and the like may be used to describe various information in the disclosed embodiments, these information should not be limited to these terms. These terms are only used to distinguish the same type of information from each other. For example, without departing from the scope of the disclosed embodiments, the first information may also be referred to as the second information, and similarly, the second information may also be referred to as the first information. Depending on the context, the word “if” as used herein may be interpreted as “at the time of” or “when” or “in response to determining”.

Referring to FIG. 1, which shows a schematic diagram of the structure of a wireless communication system according to an embodiment of the present disclosure. As shown in FIG. 1, the wireless communication system is a communication system based on cellular mobile communication technology, and the wireless communication system may include: a plurality of terminals 11 and a plurality of access devices 12.

The terminal 11 may be a device that provides voice and/or data connectivity to the user. The terminal 11 can communicate with one or more core networks via a radio access network (RAN). The terminal 11 may be an Internet of Things (IoT) terminal, such as a sensor device, a mobile phone (or a “cellular” phone), and a computer with an IoT terminal. For example, it may be a fixed, portable, pocket-sized, handheld, computer-built-in or vehicle-mounted device. For example, a station (STA), a subscriber unit, a subscriber station, a mobile station, a mobile, a remote station, an access point, a remote terminal, an access terminal, a user device, a user agent, a user equipment (UE), or a user terminal. Alternatively, the terminal 11 can also be a device of an unmanned aerial vehicle. Alternatively, the terminal 11 may be a vehicle-mounted device, such as a driving computer with wireless communication function, or a wireless communication device external to the driving computer. Alternatively, the terminal 11 may be a roadside device, such as a street lamp, signal lamp or other roadside device with wireless communication function.

The access device 12 may be a network node device in a wireless communication system. The wireless communication system may be a fourth generation mobile communication (4G) system, also known as a long term evolution (LTE) system; or, the wireless communication system may be a 5G system, also known as a new radio (NR) system or a 5G NR system. Alternatively, the wireless communication system may be a next generation system of the 5G system. The access network in the 5G system may be called a new generation-radio access network (NG-RAN). Alternatively, it may be an MTC system.

The access device 12 may be an evolved access device (eNB) adopted in the 4G system. Alternatively, the access device 12 may also be an access device (gNB) that adopts a centralized-distributed architecture in the 5G system. When the access device 12 adopts the centralized-distributed architecture, it usually includes a centralized unit (CU) and at least two distributed units (DU). The centralized unit is provided with a protocol stack of a packet data convergence protocol (PDCP) layer, a radio link control (RLC) layer, and a media access control (MAC) layer; and the distributed unit is provided with a physical (PHY) layer protocol stack. Embodiments of the present disclosure do not limit the specific implementation of the access device 12.

A wireless connection may be established between the access device 12 and the terminal 11 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard of 5G.

Optionally, the wireless communication system may further include a network management device 13. Several access devices 12 are respectively connected to the network management device 13. The network management device 13 may be a core network device in the wireless communication system. For example, the network management device 13 may be a mobility management entity (MME) in an evolved packet core (EPC). Alternatively, the network management device may also be other core network devices, such as a serving gateway (SGW), a public data network gateway (PGW), a policy and charging rules function (PCRF), a home subscriber server (HSS), or the like. Embodiments of the present disclosure do not limit the implementation form of the network management device 13.

Exemplarily, the terminal 11 may be a first UE and/or a second UE, which is configured to perform a direct sensing operation on a sensed target.

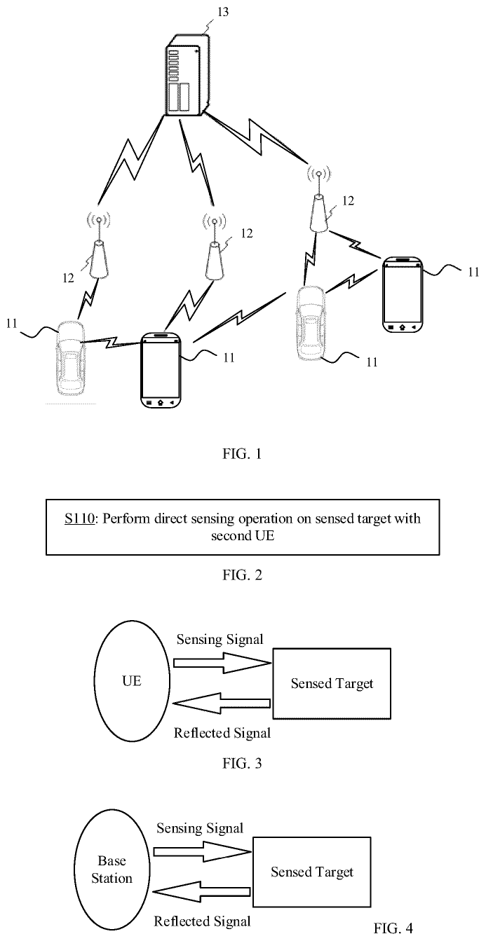

As shown in FIG. 2, an embodiment of the present disclosure provides a target sensing method, which is performed by a first UE and includes followings.

In S110, a direct sensing operation is performed on a sensed target with the second UE.

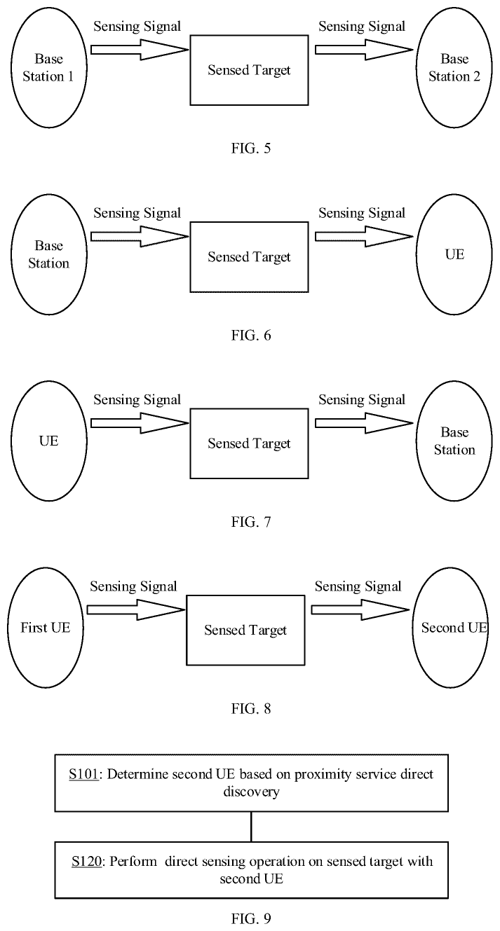

In the related art, UE may serve as a transceiver device to perform a sensing operation on a sensed target as shown in FIG. 3, or a base station may serve as a transceiver device to perform a sensing operation on a sensed target as shown in FIG. 4, or two base stations may serve as a receiver and a sender, respectively, to perform a sensing operation on a sensed target as shown in FIG. 5, or a base station and UE may serve as a receiver or a sender, respectively, to perform a sensing operation on a sensed target as shown in FIG. 6 and FIG. 7.

In the disclosed embodiments, direct sensing may refer to a direct interaction between multiple UEs without going through any network side device, such as a base station, thereby directly sensing a sensed target. For example, the first UE may be a sending device of the direct sensing operation, and the second UE may be a receiving device of the direct sensing operation; or the first UE may be a receiving device, and the second UE may be a sending device.

Here, the sending device may be a device that sends a sensing signal in the direct sensing operation, the sensing signal may be used to sense a target device, and the target device is the sensed target. The sensing signal forms a reflection signal on the sensed target, and the reflection signal is received by the receiving device, so that sensing measurement may be performed on the sensed target.

In an embodiment, when the first UE is a sending device and the second UE is a receiving device, as shown in FIG. 8, the first UE and the second UE perform a direct sensing operation on a sensed target.

In an embodiment, the sensed target is a target object to be sensed, where the sensed target may be an object other than the first UE and the second UE. For example, the sensed target may be a target object located near the first UE and the second UE or at other locations. For example, the first UE transmits a sensing signal, and the sensing signal may be reflected by the sensed target to the second UE. Exemplarily, when the sensed target is a car, the first UE and the second UE are used to directly sense the car.

In an embodiment, the first UE and the second UE may be mobile phones, tablet computers, smart watches, wearable devices, vehicle terminals, road side units (RSU), smart home terminals, industrial sensor devices and/or medical devices, or the like. The sensed target may be an object such as a terminal device with an information interaction function, or may be an object without an information interaction function.

In an embodiment, the direct sensing operation may be performed through a direct communication interface (PC5), where the PC5 interface is a communication interface of the first UE and/or the second UE, and the first UE and the second UE can complete the direct sensing operation through a PC5 link, such as performing signaling interaction carrying sensing parameters through the PC5 link.

In an embodiment, step S110 may include: upon receiving a sensing request, performing the direct sensing operation on the sensed target with the second UE. For example, upon receiving the sensing request from, for example, an application layer, another UE, a 5G core (5GC) network function (NF), or the like, the first UE performs the direct sensing operation on the sensed target with the second UE. The another UE may be any UE other than the first UE, for example, a second UE that performs a sensing operation together with the first UE, or a third UE other than the first UE or the second UE or other network devices.

In an embodiment, the method may further include: triggering a UE discovery procedure, which is used to discover the second UE. The UE discovery procedure may be triggered by means of PC5. Through the UE discovery procedure, the first UE may discover the second UE, thereby cooperating with the second UE to perform the direct sensing operation. The step may be performed before step S110. That is, the first UE performs the UE discovery procedure to discover the second UE. Then, when the first UE receives the sensing request, it may perform direct sensing of the sensed target with the second UE. However, it should be understood that the discovery procedure may also be initiated by, for example, the second UE. For example, the second UE may discover the first UE to inform the first UE of its own presence; and upon receiving the sensing request, the first UE may perform the direct sensing operation on the sensed target with the second UE.

In some possible implementations, before step S110, the method may further include: determining the second UE based on proximity service (ProSe) direct discovery. The method may include determining the second UE based on ProSe direct discovery via a PC5 interface. Alternatively, the first UE may also determine the second UE by other manners.

In an embodiment, step S110 may include: establishing a direct communication link with the second UE; and performing the direct sensing operation on the sensed target with the second UE based on the direct communication link. Establishing the direct communication link may include establishing a connection through the direct communication interface PC5.

Optionally, the first UE may establish a connection with the second UE based on PC5; determine a sensing parameter; and perform the direct sensing operation on the sensed target with the second UE based on the sensing parameter. Determining the sensing parameter may include determining the sensing parameter through negotiation with the second UE.

Here, negotiating and determining the sensing parameter may refer to determining the sensing parameter agreed by the first UE and the second UE through interaction between the first UE and the second UE. For example, the first UE may send a suggested first parameter to the second UE; and the second UE may determine whether to agree and inform the first UE through a response message sent by the second UE.

In an embodiment, establishing the connection with the second UE based on PC5 may include: sending a PC5 connection request to the second UE; and establishing the connection with the second UE based on PC5 in response to a feedback message from the second UE.

Specifically, the first UE may send the PC5 connection request to the second UE. In response to receiving the PC5 connection request from the first UE, the second UE may determine whether to accept the connection request from the first UE, and send the feedback message to the first UE to indicate whether to agree to the connection. If the second UE sends a feedback message to the first UE indicating that it agrees to the PC5 connection request initiated by the first UE, the PC5 connection is successfully established.

In an embodiment, the first UE may determine the sensing parameter. For example, the first UE may negotiate with the second UE to determine the sensing parameter. Specifically, the first UE may send a sensing request to the second UE, where the sensing request is used to carry a first parameter; then the first UE may receive a response message sent by the second UE. For example, the second UE determines the sensing parameter based on the first parameter carried in the sensing request and based on the response message.

Here, the first parameter may include a sensing parameter suggested by the first UE, that is, the first UE sends the suggested sensing parameter to the first UE. The second UE may determine whether to agree with the sensing parameter suggested by the first UE, and inform the first UE of the result through the response message. For example, the response message may be used to indicate whether the second UE agrees with the first parameter sent by the first UE. In addition, the sensing request sent by the first UE to the second UE may be a sensing request received by the first UE from the application layer, another UE, 5GC NF, or the like. The first UE forwards the received sensing request to the second UE. Alternatively, the sensing request may also be a sensing request generated by the first UE, which is not limited in the present disclosure.

In an embodiment, the sensing parameter includes or is used to indicate at least one of the following:
sensing role; UE configured to calculate the sensed result; sensed target; and single sensing or periodic sensing.

Exemplarily, the sensing parameter may indicate a sensing role. For example, the sensing parameter may include a UE identifier corresponding to a sending device, and/or a UE identifier corresponding to a receiving device, and the like. The sensing parameter may indicate the UE configured to calculate the sensed result. For example, the sensing parameter may include an identifier of UE configured to calculate the sensed result.

In an embodiment, the first parameter and the second parameter may include at least one of the following: information indicating a sensing role; information indicating the capability of calculating a sensed result; information indicating the sensed target; and information indicating single sensing or periodic sensing.

Exemplarily, the first parameter carried by the sensing request includes the information indicating the sensing role, indicating that the first UE is a sending device and/or the second UE is a receiving device. If the second UE agrees, then in the direct sensing operation performed based on the sensing parameter, the first UE is configured to send a sensing signal and the second UE is configured to receive the sensing signal. If not agreed upon, the sensing role may be determined based on the sensing role indication information in the second parameter, as indicated by the second UE.

Exemplarily, the first parameter carried by the sensing request includes the information indicating the capability of calculating the sensed result, indicating that the first UE has the capability of calculating the sensed result. If the second parameter sent by the second UE includes the information indicating capability of calculating the sensed result, indicating that the second UE does not have the capability of calculating the sensed result; then in the direct sensing operation performed based on the sensing parameter, the first UE is configured to calculate the sensed result.

Exemplarily, the first parameter carried by the sensing request includes the information indicating the sensed target, indicating the sensed target. If the second UE agrees, then in the direct sensing operation performed based on the sensing parameter, the first UE and the second UE perform the sensing operation on the indicated sensed target. If not agreed, the sensed target may be determined based on the information indicating the sensed target in the second parameter indicated by the second UE.

Exemplarily, the first parameter carried by the sensing request includes the information indicating single sensing or periodic sensing, indicating periodic sensing. Then, in the direct sensing operation performed based on the sensing parameter, the first UE and the second UE perform a periodic sensing operation on the sensed target.

In an embodiment, determining the sensing parameter based on the response message may include: determining, based on the response message, at least one second parameter indicated by the second UE based on the first parameter; and determining the sensing parameter based on the second parameter.

In an embodiment, determining the sensing parameter based on the second parameter may include using the second parameter as the sensing parameter, or using the first parameter and the second parameter as the sensing parameter, or determining an object indicated by the sensing parameter based on the second parameter, or determining an object indicated by the sensing parameter based on the first parameter and the second parameter. For example, based on the information indicating the capability of calculating the sensed result in the second parameter, UE configured to calculate the sensed result may be determined.

In an embodiment, determining the sensing parameter based on the first parameter and the second parameter may include: determining the sensing parameter based on some parameters in the second parameter that are different from the first parameter, and/or determining the sensing parameter based on some parameters in the first parameter that are the same as the second parameter or not included in the second parameter.

For example, when the information indicating sensing role included in the second parameter is different from the information indicating sensing role included in the first parameter, the information indicating sensing role included in the second parameter is used as the sensing parameter; or the UE configured to calculate the sensed result indicated by the sensing parameter is determined based on the information indicating sensing role included in the second parameter.

Here, the second parameter may include other parameters different from the first parameter indicated by the second UE when it does not agree with the first parameter provided by the first UE.

In an embodiment, the second UE may not agree with all parameters included in the first parameters, that is, the second parameter sent by the second UE is different from each parameter included in the first parameters.

In an embodiment, the second UE may not agree with some parameters included in the first parameter, that is, the second parameter sent by the second UE may be different from some parameters included in the first parameter. Exemplarily, the second parameter may include some parameters, indicated by the second UE, different from the first parameter, and may also include some parameters in the first parameter agreed by the second UE.

Exemplarily, the first parameter includes a1, b1, c1 and d1, and the second UE disagrees with a1 and b1, then the second parameter may include a2 and b2, or may include a2, b2, c1 and d1.

In an embodiment, the received response message may include: a first response message or a second response message, where the first response message may indicate that the first parameter does not need to be changed, and the second response message may carry the second parameter.

In an embodiment, the direct sensing operation may include a direct sensing process and a sensing measurement process, where the direct sensing process may be used to determine a sensed target through sensing; and the sensing measurement process may be used to perform a predetermined measurement step on the sensed target, such as measuring at least one parameter of the sensed target.

In an embodiment, the method may further include: if it is determined that the first UE is configured to calculate the sensed result based on the information indicating capability of calculating the sensed result in the first parameter and/or the second parameter, then after completing the direct sensing operation, the sensed result corresponding to the direct sensing operation is calculated.

For example, based on the information indicating capability of calculating the sensed result in the first parameter and/or the second parameter, a UE with the sensed result calculation capability is determined to be configured to calculate the sensed result, or a UE with a higher sensed result calculation capability is determined to be configured to calculate the sensed result. The UE with the higher sensed result calculation capability may be a UE with a sensed result calculation capability higher than a predetermined range, or a UE with a sensed result calculation capability higher than another UE.

In this way, direct sensing operation is performed on the sensed target by two UEs, without requiring UE to perform the sensing operation through any network-side device such as a base station, thereby being conducive to reducing interaction between the UE and the base station. Moreover, terminal capabilities of the two UEs are relied on. Compared with the sensing method relying on only one UE, the selectivity of the terminal capabilities may be improved, thereby improving the sensing efficiency and success rate.

The present disclosure provides a target sensing method, which is performed by a first UE and includes:
determining the second UE based on ProSe direct discovery.

In some embodiments of the present disclosure, determining the second UE based on the ProSe direct discovery may include determining the second UE based on the ProSe direct discovery through a PC5 interface.

As shown in FIG. 9, an embodiment of the present disclosure provides a target sensing method, which is performed by a first UE and includes followings.

In S101, a second UE is determined based on ProSe direct discovery.

In S120, a direct sensing operation is performed on a sensed target with the second UE.

In some embodiments of the present disclosure, determining the second UE based on the ProSe direct discovery may include determining the second UE based on the ProSe direct discovery through a PC5 interface.

In an embodiment, determining the second UE based on ProSe direct discovery may include: upon receiving a sensing request, determining the second UE based on ProSe direct discovery. For example, when the first UE receives a sensing request from an application layer, another UE, 5GC NF, or the like, the second UE is determined based on ProSe direct discovery. The another UE may be any UE other than the first UE, such as the second UE.

In an embodiment, step S120 may include: establishing a PC5 link with the second UE; and performing the direct sensing operation on the sensed target with the second UE based on the PC5 link.

In an embodiment, step S120 may include: establishing a connection with the second UE based on the direct communication interface PC5; determining a sensing parameter through negotiation with the second UE; and performing the direct sensing operation on the sensed target with the second UE based on the sensing parameter.

In an embodiment, the sensing parameter may indicate at least one of the following: sensing role, capability of calculating the sensed result, device for calculating the sensed result, sensed target, and single sensing or periodic sensing.

The sensing role may be the role of UE participating in the direct sensing operation during the direct sensing operation. For example, the sensing role of the first UE may be a sending device, the sensing role of the second UE may be a receiving device, and so on.

The sensed result calculation capability may be the capability of UE or another UE(s) participating in the direct sensing operation to calculate the sensed result. For example, the sensed result calculation device may be determined through negotiation based on the sensed result calculation capability. For example, if the first UE has the sensed result calculation capability and the second UE does not have the sensed result calculation capability, the first UE may be determined through negotiation as the sensed result calculation device.

Single sensing or periodic sensing may indicate that the direct sensing operation is a one-time single sensing operation or a periodic sensing operation based on a certain period.

In this way, the second UE discovered based on ProSe can better adapt to complete the direct sensing operation along with the first UE, thereby improving the success rate and effect of the direct sensing operation.

It should be noted that, for descriptions of contents that are repeated or correspond to the aforementioned embodiments, the description of relevant contents such as step S110 can be referred to, and no further details will be given here.

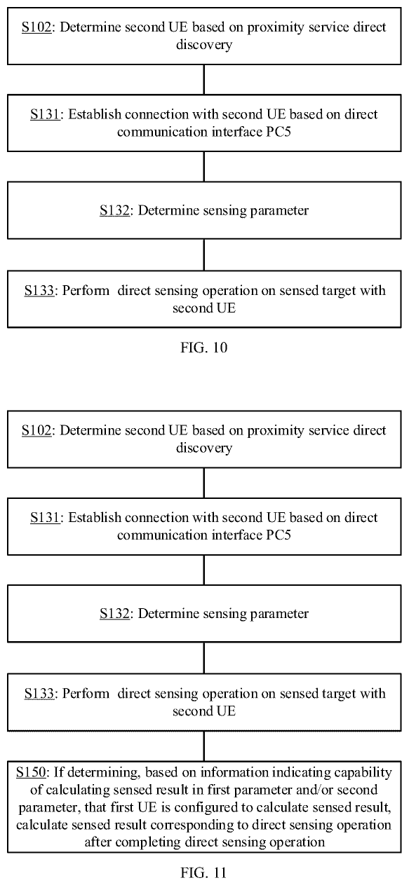

As shown in FIG. 10, an embodiment of the present disclosure provides a target sensing method, which is performed by a first UE and includes the following.

In S102, a second UE is determined based on ProSe direct discovery.

In S131, a connection is established with the second UE based on a direct communication interface PC5.

In S132, a sensing parameter is determined.

In S133, a direct sensing operation is performed on the sensed target with the second UE based on the sensing parameter.

In some embodiments of the present disclosure, establishing the connection with the second UE based on PC5 may include establishing a direct communication link with the second UE based on PC5. The sensing parameter may indicate at least one of the following: a sensing role, a sensed result calculation capability, a sensed result calculation device, a sensed target, and single sensing or periodic sensing.

In an embodiment, determining the second UE based on ProSe direct discovery may include: upon receiving a sensing request, determining the second UE based on ProSe direct discovery. For example, upon receiving a sensing request from an application layer, another UE, 5GC NF, or the like, the first UE determines the second UE based on ProSe direct discovery. The another UE may be any UE other than the first UE, such as the second UE.

In an embodiment, step S132 may include: negotiating with the second UE to determine the sensing parameter.

In an embodiment, step S132 may include: sending a sensing request to the second UE, where the sensing request is used to carry a first parameter; receiving a response message sent by the second UE based on the first parameter carried by the sensing request; and determining the sensing parameter based on the response message.

In an embodiment, step S132 may include: sending a sensing request carrying a first parameter to the second UE; and determining whether the second UE agrees with the first parameter based on a response message sent by the second UE. When it is determined that the second UE agrees with the first parameter, the sensing parameter is determined based on the first parameter. When it is determined that the second UE disagrees with the first parameter, at least one second parameter indicated by the second UE is determined based on the response message; and if the first UE agrees with the second parameter, the sensing parameter is determined based on the second parameter.

Exemplarily, determining the sensing parameter based on the first parameter may include determining the first parameter as the sensing parameter, or determining the object indicated by the sensing parameter based on the first parameter, or the like. For example, the sensed target indicated by the sensing parameter is determined based on the sensed target indication information in the first parameter.

In an embodiment, if the first UE disagrees with the second parameter, the first UE may determine the sensing parameter based on the first parameter, or determine the sensing parameter through continued negotiation with the second UE. For example, determining the sensing parameter through continued negotiation with the second UE may include: indicating to the second UE that the first parameter is the sensing parameter, or the like.

In an embodiment, step S132 may include: sending a sensing request to the second UE, where the sensing request carries a first parameter; receiving a response message sent by the second UE based on the first parameter carried by the sensing request; and determining the sensing parameter based on the response message.

In an embodiment, determining the sensing parameter based on the response message may include: determining, based on the response message, at least one second parameter indicated by the second UE based on the first parameter; and determining the sensing parameter based on the second parameter.

In an embodiment, the first parameter includes at least one of the following:
information indicating a sensing role; information indicating capability of calculating a sensed result; information indicating the sensed target; and information indicating single sensing or periodic sensing.

For example, the information indicating sensing role included in the first parameter may indicate the sensing role of the first UE and/or the second UE. The information indicating capability of calculating the sensed result in the first parameter may indicate whether the first UE has or does not have the capability of calculating the sensed result, or indicate a parameter(s) of the first UE related to the capability of calculating the sensed result. The information indicating the sensed target may be used to indicate to the second UE relevant information of the sensed target to be sensed. The information indicating single sensing or periodic sensing may be used to indicate to the second UE that a single sensing operation or a periodic sensing operation is required for the sensed target.

In an embodiment, the second parameter may include at least one of the following:
information indicating a sensing role; information indicating capability of calculating a sensed result; information indicating the sensed target; and information indicating single sensing or periodic sensing.

For example, the information indicating the sensing role included in the second parameter may be different from that included in the first parameter. For example, the information indicating sensing role in the first parameter indicates that the first UE is a sending device and the second UE is a receiving device. If the second UE disagrees with the first parameter, the information indicating sensing role in the second parameter may indicate that the second UE is a sending device and the first UE is a receiving device.

The information indicating the capability of calculating the sensed result included in the second parameter may indicate whether the second UE has or does not have the capability of calculating the sensed result, or may indicate a parameter(s) of the second UE related to the capability of calculating the sensed result.

In an embodiment, upon receiving the information indicating the sensed target and/or the information indicating single sensing or periodic sensing indicated by the first parameter, the second UE may make no change. The second parameter may not carry any parameter, indicating agreement with the first parameter; or may only include the information indicating sensing role and/or the information indicating capability of calculating the sensed result.

In an embodiment, determining the sensing parameter based on the second parameter may include: determining whether to agree with the second parameter; if yes, determining the sensing parameter corresponding to the second parameter based on the first parameter and/or the second parameter. Part of sensing parameters may be determined based on the parameters included in the second parameter (i.e., some parameters that the second UE disagrees with in the first parameter), and another part of the sensing parameters may be determined based on the parameters not included in the second parameter (i.e., some parameters that the second UE agrees with in the first parameter).

For example, if the second parameter only includes the information indicating capability of calculating the sensed result of the second UE, the sensing parameters may be determined based on the information indicating capability of calculating the sensed result included in the second parameter, as well as the information indicating the sensing role, the information indicating the sensed target, and the information indicating single sensing or periodic sensing included in the first parameter.

In an embodiment, the method may further include: determining whether the second UE has the sensed result calculation capability based on the information indicating capability of calculating the sensed result included in the second parameter; and determining a UE with the sensed result calculation capability or a higher sensed result calculation capability as the UE configured to calculate the sensed result.

In this way, the sensing parameters are determined through negotiation between the first UE and the second UE, thereby performing the direct sensing operation more accurately and reliably. Moreover, the parameter negotiation process based on the direct communication link may also be faster, more efficient, and have a high success rate.

It should be noted that, for descriptions of contents that are repeated or correspond to the aforementioned embodiments, the description of relevant contents such as step S110 can be referred to, and no further details will be given here.

As shown in FIG. 11, an embodiment of the present disclosure provides a target sensing method, which is performed by a first UE and includes the following.

In S104, a second UE is determined based on ProSe direct discovery.

In S141, a connection is established with the second UE based on the direct communication interface PC5.

In S142, a sensing parameter is determined.

In S143, a direct sensing operation is performed on the sensed target with the second UE based on the sensing parameter.

In S150, if it is determined, based on the sensed result calculation capability indication information in the first parameter and/or the second parameter, that the first UE is configured to calculate the sensed result, then after the direct sensing operation is completed, the sensed result corresponding to the direct sensing operation is calculated.

In some embodiments of the present disclosure, determining, based on the sensed result calculation capability indication information in the first parameter and/or the second parameter, that the first UE is configured to calculate the sensed result may include: determining, based on the sensed result calculation capability indication information in the first parameter and/or the second parameter, that the first UE has the sensed result calculation capability, and/or the second UE does not have the sensed result calculation capability; or, determining, based on the sensed result calculation capability indication information in the first parameter and/or the second parameter, that the sensed result calculation capability of the first UE is higher than that of the second UE.

In an embodiment, obtaining the sensed result corresponding to the direct sensing operation through calculation may refer to obtaining the sensed result corresponding to the sensing measurement in the direct sensing operation through calculation.

In this way, the UE configured to calculate the sensed result may be better determined through negotiation of the sensing parameter, thereby further improving the efficiency and accuracy of the direct sensing operation.

It should be noted that, for descriptions of contents that are repeated or correspond to the aforementioned embodiments, the description of relevant contents such as step S110 can be referred to, and no further details will be given here.

It should be noted that the technical features recorded in the aforementioned embodiments may be arbitrarily arranged and combined, and the order may be exchanged without contradiction, and may be arbitrarily combined into new technical solutions of the method.

It should be noted that those skilled in the art can understand that the method according to some embodiments of the present disclosure may be executed alone or together with the method according to these embodiments or other embodiments of the present disclosure or some methods in related art.

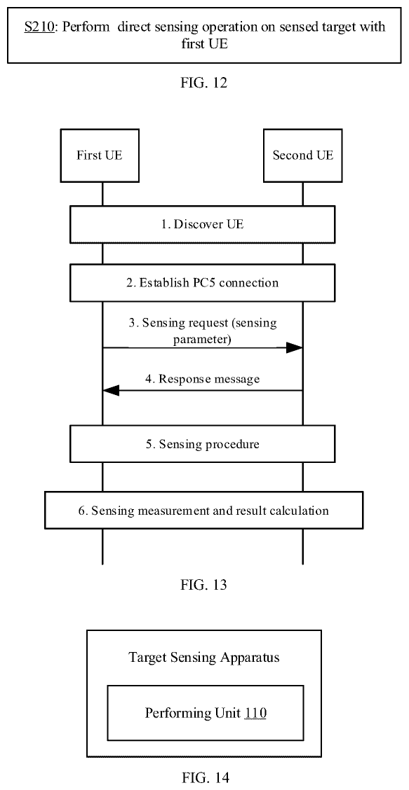

As shown in FIG. 12, an embodiment of the present disclosure provides a target sensing method performed by a second UE, which includes the following steps.

In S210, a direct sensing operation is performed on a sensed target with a first UE.

In some embodiments of the present disclosure, before step S210, the second UE may establish a connection with the first UE based on PC5, for example, establish a direct communication connection with the first UE based on PC5.

In an embodiment, after the first UE discovers the second UE through ProSe, the second UE establishes the direct communication connection with the first UE based on PC5.

In an embodiment, a PC5 connection request sent by the first UE is received; a feedback message is sent to the first UE based on the PC5 connection request; and a connection is established with the second UE based on PC5.

In an embodiment, step S210 may include: establishing a connection with the first UE based on PC5; determining a sensing parameter; and performing the direct sensing operation on the sensed target with the first UE based on the sensing parameter.

The determining of the sensing parameter may include determining the sensing parameter through negotiation with the first UE.

In an embodiment, negotiating with the first UE to determine the sensing parameter includes: receiving a sensing request sent by the first UE; sending a response message to the first UE based on a first parameter carried in the sensing request, where the response message is used to determine the sensing parameter.

In an embodiment, sending the response message to the first UE based on the first parameter carried in the sensing request includes:
determining whether to change the first parameter carried in the sensing request;
sending the response message to the first UE, thereby indicating whether to change the first parameter carried in the sensing request, wherein:
in response to determining not to change the first parameter, sending a first response message to the first UE, where the first response message indicates not to change the first parameter; and/or
in response to determining to change the first parameter, determining a second parameter based on the first parameter, and sending a second response message to the first UE, where the second response message carries a second parameter.

In an embodiment, the first parameter and the second parameter include at least one of the following:
information indicating a sensing role; information indicating capability of calculating a sensed result; information indicating the sensed target; and information indicating single sensing or periodic sensing.

In an embodiment, the method further includes:
if it is determined, based on the information indicating capability of calculating the sensed result in the first parameter and/or the second parameter, that the second UE is configured to calculate the sensed result, calculating the sensed result corresponding to the direct sensing operation after completing the direct sensing operation.

In an embodiment, the sensing parameter is used to indicate at least one of the following:
a sensing role;
UE configured to calculate a sensed result;
the sensed target; and
single sensing or periodic sensing.

It should be noted that, for descriptions of contents that are repeated or correspond to the aforementioned embodiments, the description of relevant contents such as step S110 can be referred to, and no further details will be given here.

It should be noted that the technical features recorded in the aforementioned embodiments may be arbitrarily arranged and combined, and the order may be exchanged without contradiction, and may be arbitrarily combined into new technical solutions of the method.

It should be noted that those skilled in the art can understand that the method according to some embodiments of the present disclosure may be executed alone or together with the method according to these embodiments or other embodiments of the present disclosure or some methods in related art.

Some embodiments of the present disclosure provide a target sensing system, where the system includes: a first UE and a second UE.

The first UE is configured to perform a direct sensing operation on a sensed target with the second UE.

The second UE is configured to perform the direct sensing operation on the sensed target with the first UE.

It should be noted that, for descriptions of contents that are repeated or correspond to the aforementioned embodiments, the description of relevant contents such as step S110 can be referred to, and no further details will be given here.

As shown in FIG. 13, the present disclosure provides a target sensing method, including the followings.
1. When the first UE receives a sensing request from the application layer, another UE or 5GC NF, the first UE may determine the second UE by using 5G ProSe direct discovery.
2. The first UE and the second UE establish a PC5 connection by means of PC5, where the establishment of the PC5 connection is used for signaling interaction of sensing parameter(s) between the two UEs.
3. The first UE sends a sensing request to the second UE to negotiate the sensing parameter(s). The sensing request includes some parameters, such as sensing role indication (sending device or receiving device), sensed result calculation capability indication, sensed target indication, and single sensing or periodic sensing.
4. The second UE sends a sensing response message to the first UE to reach an agreement on the parameters; or if the second UE is to change the sensing role, a new sensing role (indication) may be included in the response message.
5. The first UE and the second UE perform the direct sensing operation.
6. The sensed result is obtained by the UE with the sensed result calculation capability.

As shown in FIG. 14, an embodiment of the present disclosure provides a target sensing apparatus, which is applied to a first UE and includes:
a performing unit 110, configured to perform a direct sensing operation on a sensed target with a second UE.

In an embodiment, the apparatus further includes:
a unit 210, configured to determine the second UE based on ProSe direct discovery.

In an embodiment, the performing unit 110 is configured to:
establish a connection with the second UE based on a direct communication interface PC5;
determine a sensing parameter; and
perform the direct sensing operation on the sensed target with the second UE based on the sensing parameter.

In an embodiment, the performing unit 110 is configured to:
send a sensing request to the second UE, where the sensing request is used to carry a first parameter;
receiving a response message sent by the second UE; and
determine the sensing parameter based on the response message.

In an embodiment, the performing unit 110 is configured to:
determine, based on the response message, at least one second parameter indicated by the second UE based on the first parameter; and
determine the sensing parameter based on the second parameter.

In an embodiment, the first parameter and the second parameter include at least one of the following:
information indicating a sensing role;
information indicating capability of calculating a sensed result;
information indicating the sensed target; and
information indicating single sensing or periodic sensing.

In an embodiment, the performing unit 110 is further configured to:
if determining, based on the information indicating capability of calculating the sensed result in the first parameter and/or the second parameter, that the first UE is configured to calculate the sensed result, calculate the sensed result corresponding to the direct sensing operation after completing the direct sensing operation.

In an embodiment, the sensing parameter is used to indicate at least one of the following:
a sensing role;
UE configured to calculate a sensed result;
the sensed target; and
single sensing or periodic sensing.

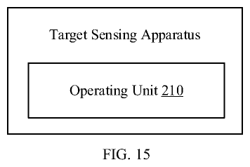

As shown in FIG. 15, an embodiment of the present disclosure provides a target sensing apparatus, which is applied to a second UE and includes:
an operating unit 210, configured to perform a direct sensing operation on a sensed target with a first UE.

In an embodiment, the operating unit 210 is configured to:
establish a connection with the first UE based on PC5;
determine a sensing parameter; and
perform the direct sensing operation on the sensed target with the first UE based on the sensing parameter.

In an embodiment, the operating unit 210 is configured to:
receive a sensing request sent by the first UE; and
send a response message to the first UE based on the first parameter carried in the sensing request, where the response message is used to determine the sensing parameter.

In an embodiment, the operating unit 210 is configured to:
determine whether to change the first parameter carried in the sensing request;
send the response message to the first UE, thereby indicating whether to change the first parameter carried in the sensing request, wherein:
in response to determining not to change the first parameter, send a first response message to the first UE, where the first response message indicates not to change the first parameter; and/or
in response to determining to change the first parameter, determine a second parameter based on the first parameter, and send a second response message to the first UE, where the second response message carries a second parameter.

In an embodiment, the first parameter and the second parameter include at least one of the following:
information indicating a sensing role; information indicating capability of calculating a sensed result; information indicating the sensed target; and information indicating single sensing or periodic sensing.

In an embodiment, the operating unit 210 is further configured to:
if determining, based on the information indicating capability of calculating the sensed result in the first parameter and/or the second parameter, that the second UE is configured to calculate the sensed result, calculate the sensed result corresponding to the direct sensing operation after completing the direct sensing operation.

In an embodiment, the sensing parameter is used to indicate at least one of the following:
a sensing role;
UE configured to calculate a sensed result;
the sensed target; and
single sensing or periodic sensing.

The present disclosure provides a communication device, including:
a memory, configured to store executable instructions of a processor; and
the processor, respectively connected to the memory;
where the processor is configured to implement the information processing method according to any of the aforementioned technical solutions.

The processor may include various types of storage medium, which are non-transitory computer storage medium that can continue to retain information stored thereon after the communication device powers off.

Here, the communication device includes: a terminal or a network element, where the network element may be any one of the first network element to the fourth network element mentioned above.

The processor may be connected to the memory via a bus or the like, and may be used to read an executable program stored in the memory to implement, for example, at least one of the methods shown in FIG. 2 or FIG. 9 to FIG. 13.

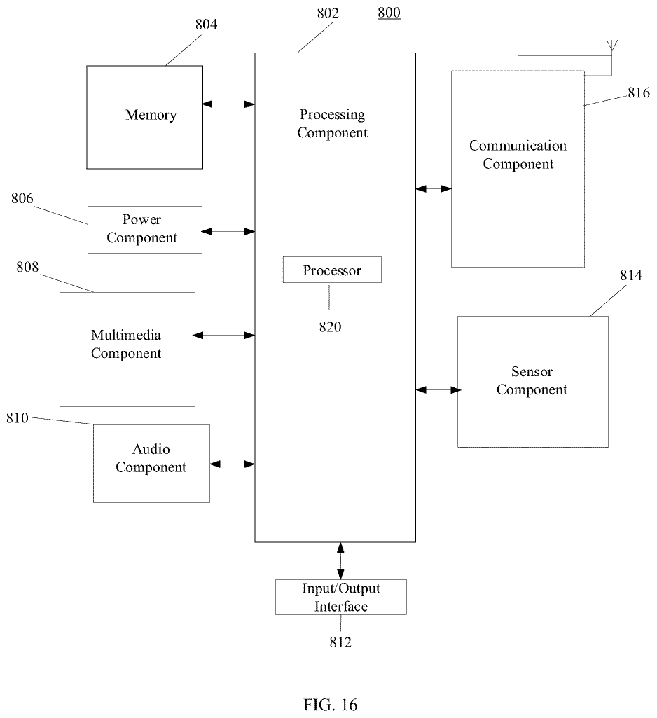

FIG. 16 is a schematic diagram of a terminal 800 according to an exemplary embodiment. For example, the terminal 800 may be a mobile phone, a computer, a digital broadcast terminal, a messaging device, a game console, a tablet device, a medical device, a fitness device, a personal digital assistant, or the like.

Referring to FIG. 16, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the terminal 800, such as operations associated with display, phone calls, data communications, camera operations, and recording operations. The processing component 802 may include one or more processors 820 to execute instructions to complete all or part of the steps of the method as described above. In addition, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support operations on the terminal 800. Examples of such data include instructions for any application or method operating on the terminal 800, contact data, phone book data, messages, pictures, videos, and the like. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to the various components of the terminal 800. The power component 806 may include a power management system, one or more power supplies, and other components associated with generating, managing, and distributing power for the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 808 includes a front camera and/or a rear camera. When the terminal 800 is in an operating mode, such as a shooting mode or a video mode, the front camera and/or the rear camera may receive external multimedia data. Each front camera and the rear camera may be a fixed optical lens system or have a focal length and optical zoom capability.

The audio component 810 is configured to output and/or input audio signals. For example, the audio component 810 includes a microphone (MIC), and when the terminal 800 is in an operating mode, such as a call mode, a recording mode, and a speech recognition mode, the microphone is configured to receive an external audio signal. The received audio signal may be further stored in the memory 804 or sent via the communication component 816. In some embodiments, the audio component 810 also includes a speaker for outputting audio signals.

Input/output interface 812 provides an interface between processing component 802 and peripheral interface modules, such as keyboards, click wheels, buttons, and the like. These buttons may include, but are not limited to, a home button, a volume button, a start button, and a lock button.

The sensor component 814 includes one or more sensors for providing various aspects of status assessment for the terminal 800. For example, the sensor component 814 can detect the turn-on/-off state of the terminal 800, the relative positioning of components, such as the display and keypad of the terminal 800. The sensor component 814 can also detect the position change of the terminal 800 or a component of the terminal 800, the presence or absence of user contact with the terminal 800, the orientation or acceleration/deceleration of the terminal 800, and the temperature change of the terminal 800. The sensor component 814 may include a proximity sensor configured to detect the presence of nearby objects without any physical contact. The sensor component 814 may also include an optical sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 can access a wireless network based on a communication standard, such as WiFi, 2G, 3G, or a combination thereof. In an exemplary embodiment, the communication component 816 receives a broadcast signal or broadcast-related information from an external broadcast management system via a broadcast channel. In an exemplary embodiment, the communication component 816 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an exemplary embodiment, the terminal 800 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the method as described above.

In an exemplary embodiment, a non-transitory computer-readable storage medium including instructions is also provided, such as the memory 804 including instructions, where the instructions may be executed by the processor 820 of the terminal 800 to perform the methods as described above. For example, the non-transitory computer-readable storage medium may be a ROM, a random access memory (RAM), a CD-ROM, a magnetic tape, a floppy disk, an optical data storage device, or the like.

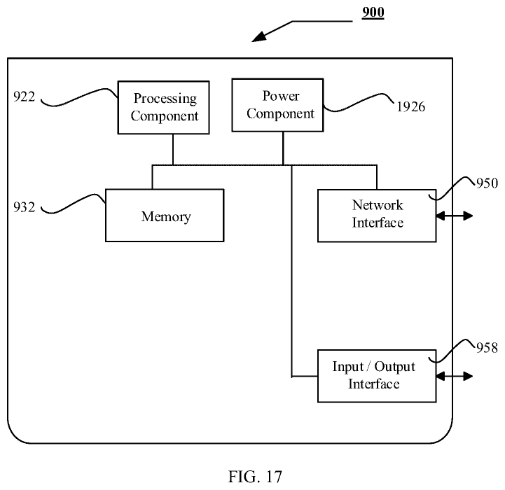

As shown in FIG. 17, an embodiment of the present disclosure illustrates the structure of a communication device 900. For example, the communication device 900 may be provided as a network node device. The communication device 900 may be the base station mentioned above.

Referring to FIG. 17, the communication device 900 includes a processing component 922, which further includes one or more processors, and a memory resource represented by a memory 932 for storing instructions executable by the processing component 922, such as an application program. The application program stored in the memory 932 may include one or more modules, each corresponding to a set of instructions. In addition, the processing component 922 is configured to execute instructions, so as to implement any method applied to the base station as mentioned above, for example, at least one of the methods as shown in FIG. 2 or FIGS. 9 to FIG. 13.

The communication device 900 may also include a power component 926 configured to perform power management for the communication device 900, a wired or wireless network interface 950 that connects the communication device 900 to a network, and an input/output (I/O) interface 958. The communication device 900 may operate based on an operating system stored in the memory 932, such as Windows Server™, Mac OS X™, Unix™, Linux™, FreeBSD™, or the like.

Those skilled in the art will readily appreciate other embodiments of the present disclosure after considering the specification and practicing the invention disclosed herein. This application is intended to cover any modifications, uses or adaptations of the present disclosure, which follow the general principles of the present disclosure and include common knowledge or customary technical means in the art that are not disclosed in the present disclosure.

It should be understood that the embodiments of the present disclosure are not limited to the precise structures described above and shown in the drawings, and various modifications and changes may be made without departing from the scope thereof. The scope of the embodiments of the present disclosure is limited only by the appended claims.

1. A method for target sensing performed by a first user equipment (UE), the method comprising:
performing a direct sensing operation on a sensed target with a second UE.

2. The method according to claim 1, further comprising:
determining the second UE based on proximity service direct discovery.

3. The method according to claim 1, wherein performing the direct sensing operation on the sensed target with the second UE comprises:
establishing a connection with the second UE based on a direct communication interface (PC5);
determining a sensing parameter; and
performing, based on the sensing parameter, the direct sensing operation on the sensed target with the second UE.

4. The method according to claim 3, wherein determining the sensing parameter comprises:
sending a sensing request to the second UE, wherein the sensing request carries a first parameter;
receiving a response message sent by the second UE; and
determining the sensing parameter based on the response message.

5. The method according to claim 4, wherein determining the sensing parameter based on the response message comprises:
determining, based on the response message, a second parameter indicated by the second UE based on the first parameter; and
determining the sensing parameter based on the second parameter.

6. The method according to claim 5, wherein the first parameter and the second parameter comprise at least one of:
information indicating a sensing role;
information indicating capability of calculating a sensed result;
information indicating the sensed target; or information indicating single sensing or periodic sensing.

7. The method according to claim 5, further comprising:
in response to determining, based on the information indicating capability of calculating the sensed result in at least one of the first parameter or the second parameter, that the first UE is configured to calculate the sensed result, calculating the sensed result corresponding to the direct sensing operation after completing the direct sensing operation.

8. The method according to claim 3, wherein the sensing parameter is used for indicating at least one of:
a sensing role;
UE configured to calculate a sensed result;
the sensed target; or
single sensing or periodic sensing.

9. A method for target sensing performed by a second user equipment (UE), the method comprising:
performing a direct sensing operation on a sensed target with a first UE.

10. The method according to claim 9, wherein performing the direct sensing operation on the sensed target with the first UE comprises:
establishing a connection with the first UE based on a direct communication interface (PC5);
determining a sensing parameter; and
performing, based on the sensing parameter, the direct sensing operation on the sensed target with the first UE.

11. The method according to claim 10, wherein determining the sensing parameter comprises:
receiving a sensing request sent by the first UE; and
sending a response message to the first UE based on a first parameter carried by the sensing request, wherein the response message is used for determining the sensing parameter.

12. The method according to claim 11, wherein sending the response message to the first UE based on the first parameter carried by the sensing request comprises:
determining whether to change the first parameter carried by the sensing request;
sending the response message to the first UE, thereby indicating whether to change the first parameter carried by the sensing request; and
in response to determining not to change the first parameter, sending a first response message to the first UE, wherein the first response message indicates not to change the first parameter; or in response to determining to change the first parameter, determining a second parameter based on the first parameter, and sending a second response message to the first UE, wherein the second response message carries the second parameter.

13. The method according to claim 12, wherein the first parameter and the second parameter comprise at least one of:
information indicating a sensing role;
information indicating capability of calculating a sensed result;
information indicating the sensed target; or
information indicating single sensing or periodic sensing.

14. The method according to claim 12, further comprising:
in response to determining, based on the information indicating capability of calculating the sensed result in at least one of the first parameter or the second parameter, that the second UE is configured to calculate the sensed result, calculating the sensed result corresponding to the direct sensing operation after completing the direct sensing operation.

15. The method according to claim 10, wherein the sensing parameter is used for indicating at least one of:
a sensing role;
UE configured to calculate a sensed result;
the sensed target; or
single sensing or periodic sensing.

16. A system for target sensing, the system comprising:
a first UE; and
a second UE; wherein:
the first UE is configured to perform a direct sensing operation on a sensed target with the second UE; and
the second UE is configured to perform the direct sensing operation on the sensed target with the first UE.

17. (canceled)

18. (canceled)

19. A communication device, comprising:
a memory that stores an executable program; and
one or more processors that are communicatively coupled to the memory,
wherein the executable program when collectively executed by the one or more processors cause the communication device to act as the first UE and perform the method according to claim 1.

20. A non-transitory computer storage medium storing an executable program thereon, wherein the executable program, when executed by a processor of the first UE, cause the first UE to perform the method according to claim 1.

21. A communication device, comprising:
a memory that stores an executable program; and
one or more processors that are communicatively coupled to the memory,
wherein the executable program when collectively executed by the one or more processors cause the communication device to act as the second UE and perform the method according to claim 9.

22. A non-transitory computer storage medium storing an executable program thereon, wherein the executable program when executed by a processor of the second UE, cause the second UE to perform the method according to claim 9.
